(19) United States
(12) Patent Application Publication
(10) Pub. No.: US 2026/0170415 A1
(43) Pub. Date: Jun. 18, 2026

(54) TRAINING METHOD AND TRAINING DEVICE FOR BIOMETRIC INFORMATION FORGERY DETECTION MODEL

(71) Applicant: SAMSUNG ELECTRONICS CO., LTD., Suwon-si (KR)

(72) Inventors: Moonkyu SONG, Suwon-si (KR); Joohwan KIM, Suwon-si (KR); Junseo LEE, Suwon-si (KR); Han-Ju JE, Suwon-si (KR)

(73) Assignee: SAMSUNG ELECTRONICS CO., LTD., Suwon-si (KR)

(21) Appl. No.: 19/416,435

(22) Filed: Dec. 11, 2025

(30) Foreign Application Priority Data
Dec. 13, 2024 (KR) 10-2024-0186474

(51) Int. Cl. G06N 20/00; G06F 21/32

(52) U.S. Cl. CPC G06N 20/00; G06F 21/32

(57) ABSTRACT

A training method of a biometric information forgery detection model includes selecting first data and second data, extracting non-biometric information of the first data and biometric information of the second data using a deep learning-based generative model, generating a training data candidate by transferring the non-biometric information of the first data to the biometric information of the second data using the generative model, extracting first biometric information and first quality information of the training data candidate, evaluating the first biometric information and the first quality information of the training data candidate based on predetermined quality criteria, and selecting a training data candidate satisfying the quality criteria to set training data.

### CROSS-REFERENCE TO RELATED APPLICATION(S)

This U.S. non-provisional application claims priority under 35 USC § 119 to Korean Patent Application No. 10-2024-0186474, filed on Dec. 13, 2024, in the Korean Intellectual Property Office, the disclosure of which is herein incorporated by reference in its entirety.

### BACKGROUND

The present disclosure relates to a method and a device for training models to detect forgery of biometric information.

Various types of biometric information, such as fingerprints and irises, are being used to authenticate legitimate users. For example, for biometric authentication, various electronic devices such as smartphones and smart cards authenticate users using fingerprint information.

User authentication technology using biometric information may be attacked by forging the biometric information of legitimate users. For example, a fingerprint pattern of a legitimate user transferred to a silicone cover may pass through authentication technology based on simple biometric information comparison. To defend against such attacks, there is a technology for performing liveness detection on biometric data acquired by sensors. The liveness detection is a security technology that verifies a subject from which biometric information was acquired is a real person or a fake object.

### SUMMARY

One or more embodiments provide a training method and a training device for a biometric information forgery detection model. More specifically, one or more embodiments provide a training method and a training device enabling cost-effective training of a biometric information forgery detection model while maintaining or enhancing the detection performance thereof.

According to one or more embodiment, a training method of a biometric information forgery detection model includes selecting first data and second data, extracting non-biometric information of the first data and biometric information of the second data using a deep learning-based generative model, generating a training data candidate by transferring the non-biometric information of the first data to the biometric information of the second data using the generative model, extracting first biometric information and first quality information of the training data candidate, evaluating the first biometric information and the first quality information of the training data candidate based on predetermined quality criteria, and selecting a training data candidate satisfying the quality criteria to set training data.

According to one or more embodiments, a training device of a biometric information forgery detection model includes a processor and a memory electrically connected to the processor and configured to store at least one instruction executed by the processor. The at least one instruction may control the processor to select first data and second data, extract non-biometric information of the first data using a deep learning-based generative model, generate a training data candidate by transferring the non-biometric information of the first data to biometric information of the second data using the generative model, calculate first biometric information and first quality information of the training data candidate, evaluate the first biometric information and the first quality information of the training data candidate based on predetermined quality criteria, and select a training data candidate, satisfying the quality criteria, to generate training data.

According to one or more embodiments, a training method of a biometric information forgery detection model includes selecting first data and second data, extracting non-biometric information of the first data using a deep learning-based generative model, generating a training data candidate by transferring the non-biometric information of the first data to biometric information of the second data using the generative model, evaluating a quality of the training data candidate based on predetermined quality criteria, and setting the training data candidate, satisfying the quality criteria, as training data.

### BRIEF DESCRIPTION OF DRAWINGS

FIG. 1 is a schematic block diagram illustrating the configuration of a biometric recognition system according to one or more embodiments.

FIG. 2 is a flowchart illustrating a training method of a biometric information forgery detection model according to one or more embodiments.

FIG. 3 is a block diagram illustrating the configuration of a training device for a biometric information forgery detection model according to one or more embodiments.

FIG. 4 is a diagram illustrating the configuration and operation of a training data candidate generator according to one or more embodiments.

FIG. 5 is diagrams illustrating the configuration and operation of a biometric information extractor according to one or more embodiments.

FIGS. 6A and 6B are diagrams illustrating the configuration and operation of a quality information extractor according to one or more embodiments.

FIG. 7 is a diagram illustrating the configuration of a quality information and parameter mapping list according to one or more embodiments.

FIG. 8 is a diagram illustrating an operation in which a training device according to one or more embodiments labels generated training data.

FIG. 9 is a diagram illustrating an operation in which a training device according to one or more embodiments generates a plurality of candidate training data sets.

FIG. 10 is a diagram illustrating an operation of adjusting a training data candidate generator based on the detection performance of a biometric information forgery detection model in a training device of the biometric information forgery detection model.

FIG. 11 is a diagram illustrating an example of the configuration of a biometric information forgery detection model according to one or more embodiments.

FIG. 12 is a diagram illustrating an example of the configuration of a biometric information forgery detection model.

FIG. 13 is a diagram illustrating an example of the configuration of a training device of a biometric information forgery detection model.

### DETAILED DESCRIPTION

Hereinafter, one or more embodiments will be described with reference to the accompanying drawings.

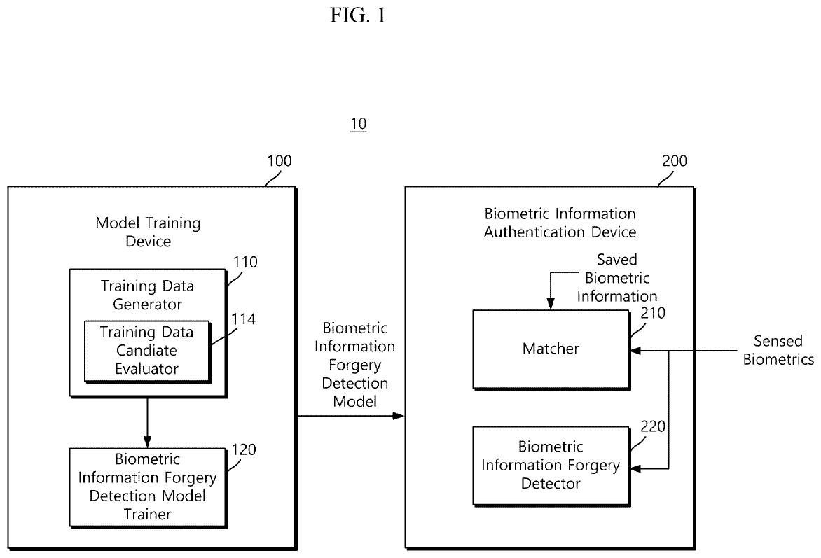

FIG. 1 is a schematic block diagram illustrating a configuration of a biometric system 10 according to one or more embodiments.

The biometric system 10 may include a training device 100 for a biometric information forgery detection model (hereinafter referred to as a “training device”) and a biometric information authentication device 200 according to one or more embodiments.

The training device 100 may generate at least a portion of training data. The training device 100 may train the biometric information forgery detection model using the training data. The training device 100 may provide fully or partially trained biometric information forgery detection model to the biometric information authentication device 200 online or offline.

In certain embodiments, biometric information may be information obtainable from a part of the body, such as fingerprint information, iris information, or vein information.

The biometric information authentication device 200 may authenticate biometric information obtained using a biometric sensor. In certain embodiments, the biometric sensor may include an image sensor, an ultrasonic sensor, a capacitive sensor, an infrared sensor, a visible light sensor, an optical sensor, or the like. The biometric information authentication device 200 may authenticate whether a user providing the biometric information is a legitimate user.

In the present disclosure, examples are provided in which the biometric information is fingerprint information. However, embodiments are not limited to fingerprint information.

The biometric information authentication device 200 may obtain user's fingerprint information using an image sensor, an ultrasonic sensor, a capacitive sensor, or the like. The fingerprint information may be a fingerprint image.

The biometric information authentication device 200 may determine whether the obtained fingerprint information is the same as stored fingerprint information. In addition, the biometric information authentication device 200 may perform liveness detection on the obtained fingerprint information. For example, the biometric information authentication device 200 may verify whether the obtained fingerprint information is obtained from an actual human finger or from an object.

In certain embodiments, the biometric information authentication device 200 may include a preprocessing unit. The preprocessing unit may preprocess the obtained fingerprint information. For example, when the fingerprint information is a fingerprint image, the preprocessing unit may perform binarization, smoothing, thinning, or the like, on the fingerprint image.

The biometric information authentication device 200 may include a matcher 210 verifying the identity of the obtained fingerprint information with stored fingerprint information and a biometric information forgery verification unit 220 performing liveness detection on the obtained fingerprint information.

The matcher 210 may extract characteristic information, unique to the fingerprint information, from the obtained fingerprint information. For example, the matcher may extract minutiae, direction characteristics, or the like, of the fingerprint. Minutiae may include various types of feature points such as ending points, bifurcations, trifurcations or crossovers, cores, or deltas. Direction characteristics may include ridge direction information.

The matcher 210 may compare the characteristic information, unique to the fingerprint information extracted from the obtained fingerprint information, with stored characteristic information.

The biometric information forgery detector 220 may perform liveness detection on the obtained fingerprint information.

In certain embodiments, the biometric information forgery detector 220 may perform liveness detection on the obtained fingerprint information using a biometric information forgery detection model. The biometric information forgery detection model may be provided by the training device 100, as described above. The biometric information forgery detection model may be a deep learning-based detection model. The biometric information forgery detection model may be a convolutional neural network (CNN) detection model.

The training device 100 according to one or more embodiments may include a training data generator 110 generating at least a portion of training data for training a biometric information forgery detection model performing liveness detection. The training data generator 110 may generate at least a portion of the training data using a generative model transferring non-biometric information. Accordingly, the training device 100 may generate various types of training data to enable cost-effective training of the biometric information forgery detection model.

For example, the training data generator 110 may generate training data by transferring non-biometric information from first data including forged biometric information to second data including real biometric information. In addition, the training device 100 may generate training data by transferring non-biometric information from first data including real biometric information to second data including real biometric information.

The training data generator 110 may evaluate the quality of the generated training data. For example, the training data generator 110 may set the generated training data as training data candidates and include a training data candidate evaluator 114 evaluating the training data candidates using predetermined quality criteria.

The quality criteria may be predetermined reference values for quality features. The reference values may be predetermined for at least one quality feature. The quality feature may be provided in plurality.

The training device 100 may include training data candidates satisfying the predetermined quality criteria in the training data. The biometric information forgery detection model trainer 120 of the training device 100 may train the biometric information forgery detection model using the training data.

In certain embodiments, the training device 100 may use only the training data candidates satisfying the quality criteria, among the generated training data candidates for training the biometric information forgery detection model. Accordingly, the biometric information forgery detection model may be trained using training data with quality above the predetermined criteria, enabling the training device 100 to train the biometric information forgery detection model stably and efficiently.

In certain embodiments, the training data generator 110 and the biometric information forgery detection model trainer 120 may be implemented in a logic circuit.

In certain embodiments, the training data generator 110 and the biometric information forgery detection model trainer 120 may be implemented in a specific-purpose processor.

In certain embodiments, the training data generator 110 and the biometric information forgery detection model trainer 120 may be implemented in a general-purpose processor.

In certain embodiments, the training data generator 110 and the biometric information forgery detection model trainer 120 may be implemented by instructions executed in a processor. The instructions may be stored in a memory device of the training device 100. The memory device may be electrically connected to the processor.

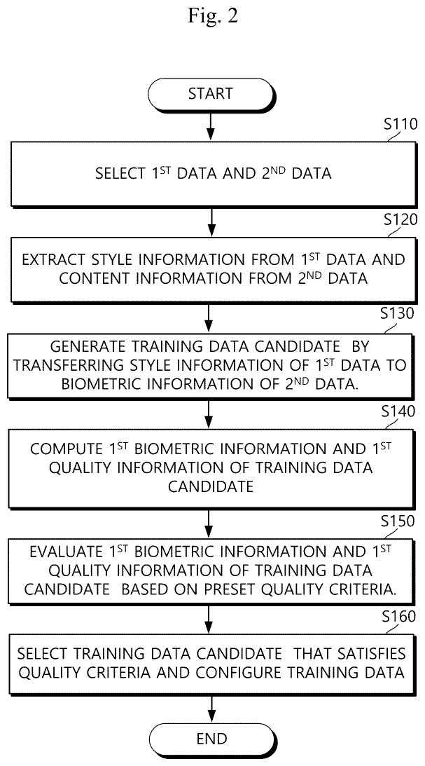

FIG. 2 is a flowchart illustrating a training method of a biometric information forgery detection model according to one or more embodiments. The training method of the biometric information forgery detection model illustrated in FIG. 2 may be performed by the training device 100 of FIG. 1.

Referring to FIG. 2, in operation S110, the training device 100 may select first data and second data to generate training data candidates.

In certain embodiments, the first data may include forged biometric information, and the second data may include real biometric information. Alternatively, both the first data and the second data may include real biometric information.

In operation S120, the training device 100 may extract non-biometric information from the first data and biometric information from the second data.

For example, the training device 100 may extract the non-biometric information of the first data and the biometric information of the second data as feature maps using an encoder of a generative model transferring non-biometric information.

In certain embodiments, non-biometric information may include style information. The non-biometric information may include material information. The non-biometric information may include information other than biometric information.

In operation S130, the training device 100 may transfer the non-biometric information of the first data to the biometric information of the second data using the generative model.

For example, the training device 100 may combine a first feature map, extracted from the non-biometric information of the first data, with a second feature map, extracted from the biometric information of the second data, using internal network layers of the generative model transferring the non-biometric information.

The training device 100 may set the second data, to which the non-biometric information of the first data has been transferred, as a training data candidate.

In operation S140, the training device 100 may compute first biometric information and first quality information of the training data candidate.

In certain embodiments, the first biometric information may be characteristic information unique to the fingerprint information of the training data candidate. For example, the first biometric information may include feature points, direction characteristics, or the like, extracted from the training data candidate. For example, the first biometric information may include features extracted from training data candidates, such as ending points, bifurcations, trifurcations or crossovers, cores, or deltas, ridge direction information, and ridge-valley direction information.

In certain embodiments, the first quality information may include secondary information calculated from the characteristic information unique to the fingerprint information of the training data candidate. For example, the first quality information may include statistical information of the characteristic information unique to the fingerprint information.

In certain embodiments, the first quality information may refer to the quality of the data itself of the training data candidate. For example, when the training data candidate is a fingerprint image, the first quality information may include an average grayscale value of the training data candidate, an average grayscale value per block of the training data candidate, a proportion of a fingerprint in an image, or a determination as to whether the fingerprint is a wet fingerprint.

The first biometric information and the first quality information may be calculated using various methods in addition to the above-described computing method, and types thereof are not limited.

In operation S150, the training device 100 may evaluate the first biometric information and the first quality information of the training data candidate based on predetermined quality criteria. For example, the training device 100 may check whether the first biometric information and the first quality information of the training data candidate satisfy the predetermined quality criteria.

In operation S160, when the first biometric information and the first quality information satisfy the predetermined quality criteria, the training device 100 may set the training data candidate as training data.

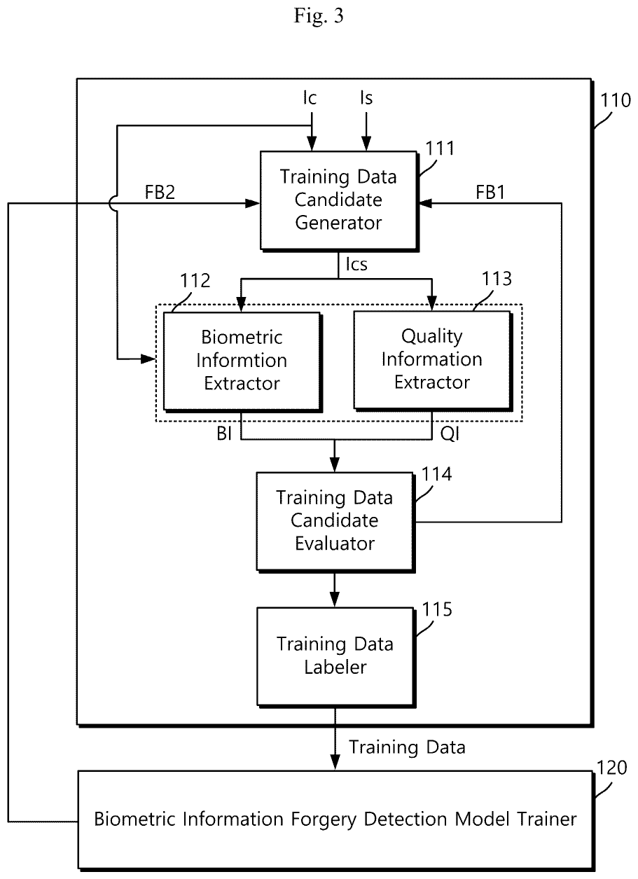

FIG. 3 is a block diagram illustrating the configuration of a training device for a biometric information forgery detection model according to one or more embodiments. The training device 100 of FIG. 3 may correspond to the training device 100 of FIG. 1. Each component may be firmware, software, hardware, or combinations thereof. The training device 100 of FIG. 3 may perform the training method of FIG. 2.

The configuration and training method of the training device 100 will now be described in detail with reference to FIG. 3.

Referring to FIG. 3, the training device 100 may include a training data generator 110 and a biometric information forgery detection model trainer 120.

The training data generator 110 may generate at least one training data based on first data Is and second data Ic. The biometric information forgery detection model trainer 120 may train the biometric information forgery detection model using the generated at least one training data.

In certain embodiments, the training data generator 110 may include a training data candidate generator 111, a biometric information extractor 112, a quality information extractor 113, a training data candidate evaluator 114, and a training data labeler 115.

The training data candidate generator 111 may select the first data Is and the second data Ic.

The first data Is may include forged biometric information or real biometric information. The second data Ic may include real biometric information.

The training data candidate generator 111 may extract non-biometric information from the first data Is and biometric information from the second data Ic. The training data candidate generator 111 may generate a training data candidate Ics by transferring the non-biometric information of the first data Is to the biometric information of the second data Ic. In certain embodiments, the training data candidate generator 111 may generate the training data candidate Ics using a generative model.

The biometric information extractor 112 and the quality information extractor 113 may extract the first biometric information BI and the first quality information QI of the training data candidate Ics, respectively.

The training data candidate evaluator 114 may evaluate the first biometric information BI and the first quality information QI of the training data candidate Ics. The training data candidate evaluator 114 may check whether at least one of the first biometric information BI and the first quality information QI satisfies the predetermined quality criteria.

In certain embodiments, the biometric information extractor 112 and the quality information extractor 113 may extract the second biometric information and the second quality information of the second data Ic, respectively.

The second biometric information and the second quality information of the second data Ic may be extracted from the second data Ic in the same manner as or similar manner to the first biometric information and the first quality information. The biometric information extractor 112 and the quality information extractor 113 may extract the second biometric information and the second quality information from the second data Ic in the same manner as the first biometric information and the first quality information.

The training data candidate evaluator 114 may compute a first comparison result obtained by comparing the first biometric information with the second biometric information, or compute a second comparison result obtained by comparing the first quality information with the second quality information.

Accordingly, the training data candidate evaluator 114 may evaluate the training data candidate based on the relative quality of the training data candidate for the second data Ic containing real biometric information.

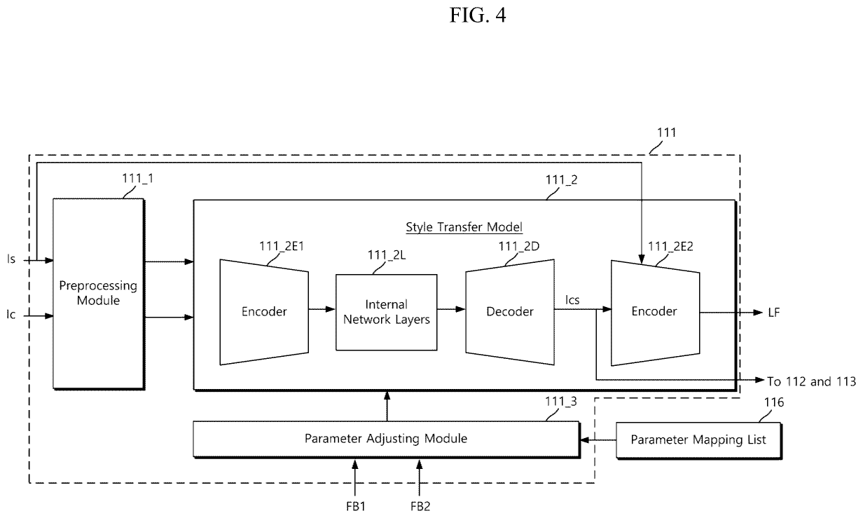

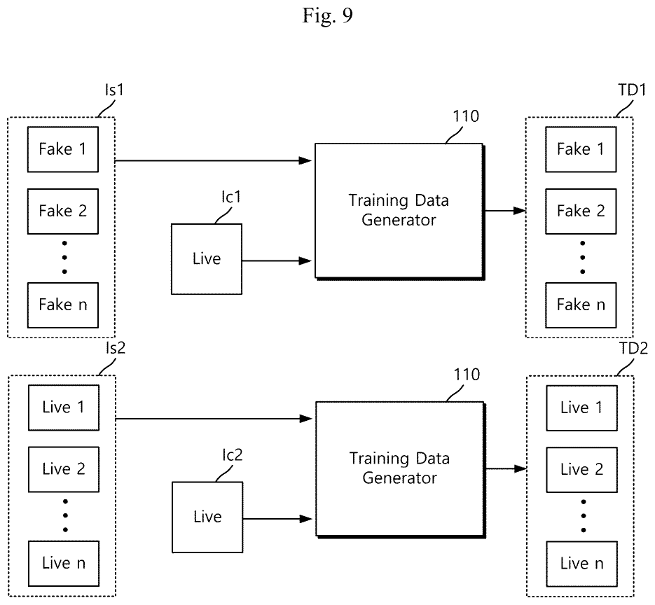

In certain embodiments, the training data candidate generator 111 may generate a training data candidate based on first feedback FB1 provided by the training data candidate evaluator 114. This will be described in detail below with reference to FIGS. 4 and 8.

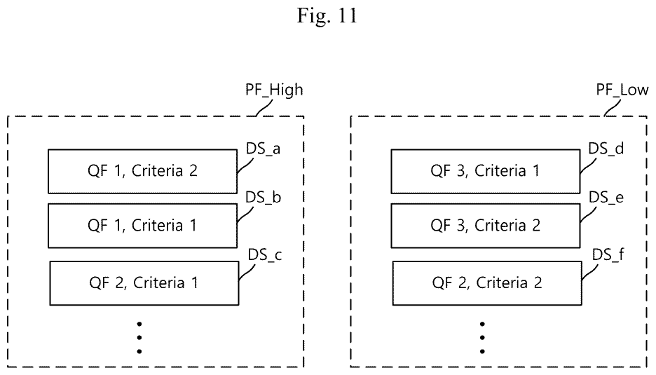

In certain embodiments, the training data candidate generator 111 may generate a training data candidate based on second feedback FB2 provided by the biometric information forgery detection model trainer 120. This will be described in detail below with reference to FIGS. 4 and 11.

FIG. 4 is a diagram illustrating the configuration and operation of a training data candidate generator 111 according to one or more embodiments. The training data candidate generator 111 of FIG. 4 may correspond to the training data candidate generator 111 of FIG. 3.

The training data candidate generator 111 according to one or more embodiments will now be described with reference to FIG. 4.

Referring to FIG. 4, the training data candidate generator 111 may include a preprocessing module 111_1, a non-biometric information transfer model 111_2, and a parameter adjusting module 111_3.

In certain embodiments, the preprocessing module 111_1 may perform at least one of preprocessing operations such as binarization, smoothing, thinning, or noise removal on fingerprint images of the first data Is and the second data Ic.

The non-biometric information transfer model 111_2 may generate a training data candidate Ics from the preprocessed first data Is and second data Ic. For example, the non-biometric information transfer model 111_2 may transfer the non-biometric information of the first data Is to the biometric information of the second data Ic to generate the training data candidate Ics.

The non-biometric information transfer model 111_2 may be a generative model.

In certain embodiments, the non-biometric information transfer model 111_2 may include an encoder 111_2E1, internal network layers 111_2L, and a decoder 111_2D.

The encoder 111_2E1 may extract each of the non-biometric information of the first data Is and the biometric information of the second data Ic as a feature map.

In certain embodiments, the encoder 111_2E1 may include at least one convolution layer based on a ReLU activation function, at least one pooling layer, and at least one dense layer. For example, the encoder 111_2E1 may be a VGG-based encoder. However, the encoder according to one or more embodiments is not limited to a VGG-based encoder.

The internal network layers 111_2L may combine a first feature map, from which the non-biometric information of the first data Is is extracted, with a second feature map from which the biometric information of the second data Ic is extracted.

In certain embodiments, the internal network layers 111_2L may include at least one convolution layer and a softmax activation function. For example, the internal network layers 111_2L may include a SANet embedding network. For example, the internal network layers 111_2L may include an adaptive instance normalization (AdaIN) layer. However, the internal network layers 111_2L are not limited to the SANet embedding network or the AdaIN layer.

The decoder 111_2D may be symmetrical to a structure of the encoder 111_2E1. The decoder 111_2D may convert the combined feature map into a training data candidate Ics. The training data candidate Ics may be transmitted to each of the biometric information extractor 112 and the quality information extractor 113 of FIG. 3.

The training data candidate Ics may be input to an encoder 111_2E2 and the output of the encoder 111_2E2 may be provided to a loss function LF to train the non-biometric information transfer model 111_2.

The training device 100 may train the non-biometric information transfer model 111_2 based on the loss function LF. The loss function LF may be defined and used in various ways. For example, the loss function LF may be defined as a weighted sum of a plurality of sub-loss functions. The plurality of sub-loss functions may include a non-biometric information loss function, a biometric information loss function, and an identity loss function, respectively.

In certain embodiments, the non-biometric information loss function may be a loss function based on a difference between the first data Is and the training data candidate Ics.

In certain embodiments, the biometric information loss function may be a loss function based on a difference between the second feature map extracted from the biometric information of the second data Ic and the training data candidate Ics.

In certain embodiments, the identity loss function may be a loss function based on a first difference between the first feature map and a first virtual training data candidate and a second difference between the second feature map and a second virtual training data candidate. The first virtual training data candidate may be a training data candidate output by the non-biometric information transfer model 111_2 with two pieces of identical first data Is as an input. The second virtual training data candidate may be a training data candidate output by the non-biometric information transfer model 111_2 with two pieces of identical second data Ic as an input.

The training device 100 may define the loss function LF in various ways to train the non-biometric information transfer model 111_2.

In certain embodiments, the parameter adjusting module 111_3 may receive first feedback FB1 and second feedback FB2 and adjust parameters of the non-biometric information transfer model 111_2 based on a parameter mapping list 116.

For example, the parameter adjusting module 111_3 may adjust parameters corresponding to the quality items indicated in the first feedback FB1. Alternatively, the parameter adjusting module 111_3 may adjust parameters corresponding to the quality items indicated in the second feedback FB2.

In certain embodiments, the parameters corresponding to the quality features may be defined in the parameter mapping list 116.

In certain embodiments, an adjust unit for each parameter may be defined in the parameter mapping list 116.

For example, when the loss function LF is defined as a weighted sum of the plurality of sub-loss functions, the parameter adjusting module 111_3 may adjust the weights of the sub-loss functions. By adjusting the weights of the sub-loss functions, the parameter adjusting module 111_3 may allow the training data candidate Ics to reflect more of the non-biometric information of the first data Is or more of the biometric information of the second data Ic. Alternatively, the parameter adjusting module 111_3 may adjust the weight of the identity loss function to control the extent to which the structure of the biometric information is maintained.

In addition, various parameters within the non-biometric information transfer model 111_2 may be adjusted. For example, parameters such as a stride size or a pooling size of the encoder 111_2E1 or weight values of the weight matrices used in the internal network layers 111_2L may be adjusted.

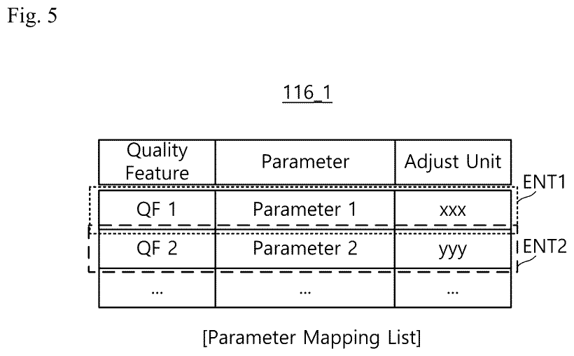

FIG. 5 is a diagram illustrating an example of the configuration of a parameter mapping list 116_1 according to one or more embodiments. The parameter mapping list 116_1 of FIG. 5 may correspond to the parameter mapping list 116 of FIG. 4.

In certain embodiments, the parameter mapping list 116_1 may store information on quality features and corresponding parameters thereof.

In certain embodiments, the quality features may be based on quality information and biometric information.

For example, the quality features may be related to quality information such as the number of extracted feature points, OCL, OF, RVU, or the like. The quality features may be secondary and/or tertiary information determined in a predetermined manner from the number of extracted feature points, OCL, OF, RVU, or the like.

For example, the quality features may be related to characteristic information, unique to fingerprint information. The quality features may include various types of feature points such as ending points, bifurcations, trifurcations or crossovers, cores, or deltas, or ridge direction information.

The parameters corresponding to the quality features may be experimentally determined in advance. For example, when experimentally changing the value of a first parameter of the non-biometric information transfer model 111_2 of FIG. 4 causes a value of a first quality feature of the training data candidate Ics output by the non-biometric information transfer model 111_2 to be changed beyond a predetermined criterion, the first parameter may be set in the parameter mapping list 116_1 as corresponding to the first quality feature.

In some embodiments, the same parameter of the same non-biometric information transfer model 111_2 may correspond to the plurality of different quality features.

The parameter mapping list 116_1 may include the plurality of entries ENT1 and ENT2. Each of the plurality of entries ENT1 and ENT2 may store a correspondence between quality features QF1 and QF2 and parameters Parameter 1 and Parameter 2.

In certain embodiments, each of the plurality of entries ENT1 and ENT2 may store adjust units xxx and yyy for the respective parameters Parameter 1 and Parameter 2. The parameter adjusting module 111_3 of FIG. 4 may adjust the parameters Parameter 1 and Parameter 2 by the respective adjust units xxx and yyy. For example, when the first feedback FB1 indicates the first quality feature QF1, the parameter adjusting module 111_3 of FIG. 4 may change a value of the first parameter Parameter 1 by the first adjust unit xxx. The adjust units xxx and yyy for changing the values of the parameters Parameter 1 and Parameter 2 may be experimentally preset.

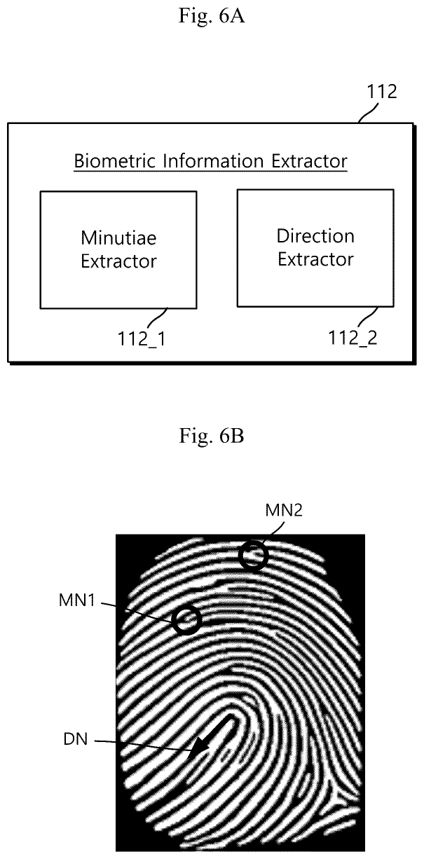

FIGS. 6A and 6B are diagrams illustrating the configuration and operation of a quality information extractor 112 according to one or more embodiments. The biometric information extractor 112 of FIG. 6a may be used in the training device 100 of FIG. 1 and the training data generator 110 of FIG. 3.

Referring to FIG. 6A, the biometric information extractor 112 may extract information unique to biometric information from input data. The information unique to biometric information may vary depending on the type of biometric information. In FIGS. 6A and 6B, an example is provided in which input data includes fingerprint information. The input data may be, for example, a fingerprint image.

The biometric information extractor 112 may extract fingerprint feature points and directional characteristics from the input data. For example, the biometric information extractor 112 may extract fingerprint feature points and direction characteristics from the biometric information of the second data Ic of FIG. 3.

Referring to FIG. 6A, the biometric information extractor 112 may include a minutiae extractor 112_1 and a direction extractor 112_2. When the biometric information of the second data Ic is a fingerprint image, the minutiae extractor 112_1 may extract at least one of various types of feature points, such as ending points, bifurcations, trifurcations or crossovers, cores, or deltas, from the fingerprint image. The direction extractor 112_2 may extract ridge direction information as directional characteristics from the fingerprint image. The ridge direction information may include local directions of respective parts of ridge-valley patterns. For example, the ridge direction information may include tangent directions of ridges disposed in respective grids after dividing the fingerprint image into regular grids. Alternatively, the ridge direction information may include direction points, which are points at which the ridge direction changes beyond a predetermined criterion.

FIG. 6B illustrates a fingerprint image of the second data Ic represented with white ridges and black valleys. FIG. 6B illustrates a first feature point MN1 as an ending point, a second feature point MN2 as a bifurcation, and direction information DN as a direction vector of a specific part, among the feature points.

One or more embodiments are not limited to the fingerprint feature points and ridge direction information mentioned in the embodiments described with reference to FIGS. 6A and 6B. The biometric information extractor 112 may extract fingerprint feature points and ridge direction information using various other methods.

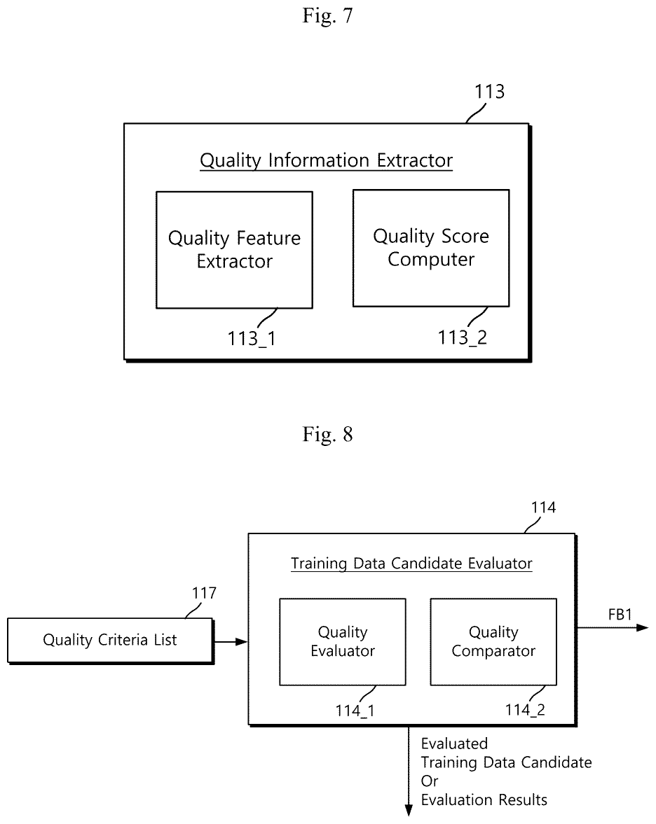

FIGS. 7A and 7B are diagrams illustrating the configuration and operation of the quality information extractor 113 according to one or more embodiments. The biometric information extractor 112 of FIG. 7a may be used in the training device 100 of FIG. 1 and the training data generator 110 of FIG. 3.

Referring to FIG. 7A, the quality information extractor 113 may include a quality feature extractor 113_1 and a quality score computer 113_2.

The quality feature extractor 113_1 may extract quality information from a training data candidate.

In certain embodiments, the quality information may include secondary information computed from characteristic information, unique to the fingerprint information of the training data candidate. For example, the quality feature extractor 113_1 may extract information such as the number of feature points extracted from the training data candidate, an orientation certainty level (OCL) indicating the strength of energy concentration in a dominant ridge flow direction, an orientation flow (OF) indicating the continuity of ridge flow, and ridge valley uniformity (RVU) indicating the uniformity of the pattern formed by ridges and valleys, using various calculation methods.

In certain embodiments, the quality information may include statistical information based on secondary information calculated from characteristic information unique to fingerprint information. For example, the quality feature extractor 113_1 may extract statistical information such as the number of feature points per block of a predetermined size, the average and standard deviation of OCL, or the like, from the training data candidate.

In certain embodiments, the quality information may refer to the quality of the data itself of the training data candidate. For example, if the training data candidate is a fingerprint image, the quality feature extractor 113_1 may include the average grayscale value of the training data candidate, the average grayscale value per block of the training data candidate, or the like.

The quality feature extractor 113_1 may extract quality information using various methods other than the above-described computation methods, and the types thereof are not limited.

The quality score computer 113_2 may compute a score for the quality information extracted by the quality feature extractor 113_1 based on predetermined criteria or methods. In certain embodiments, the score of the quality information may be a result of a relative evaluation and/or a comparative evaluation of the extracted quality information.

For example, the quality score computer 113_2 may compute scores using various methods, such as a proportion of a fingerprint in an image, a determination as to whether the fingerprint is a wet fingerprint, a determination of whether the number of feature points is less than a predetermined threshold, or a score based on a linear combination of the plurality of quality information features.

For example, the quality score computer 113_2 may compute a ratio or comparison result of the quality feature values extracted from the training candidate data relative to the reference values of predetermined quality features.

FIG. 8 is a diagram illustrating the configuration and operation of the training data candidate evaluator 114 according to one or more embodiments. The training data candidate evaluator 114 of FIG. 8 may be used in the training device 100 of FIG. 1.

Referring to FIG. 8, the training data candidate evaluator 114 may include a quality evaluator 114_1 and a quality comparator 114_2.

The quality evaluator 114_1 may evaluate first biometric information and first quality information of the training data candidate. The quality evaluator 114_1 may check whether at least one of the first biometric information and the first quality information satisfies predetermined quality criteria.

In certain embodiments, the quality evaluator 114_1 may compare the first biometric information and the first quality information of the training data candidate with predetermined quality criteria and determine the quality of the training data candidate. The quality evaluator 114_1 may compare a reference value of each of the predetermined quality features in a quality criteria list 117 with the first biometric information and the first quality information.

For example, the quality evaluator 114_1 may determine whether the number of feature points such as ending points, bifurcations, crossovers, cores, deltas, ridge direction information, or ridge-valley direction information, extracted from the training data candidate, meets or exceeds the quality criteria predetermined in the quality criteria list 117.

For example, the quality evaluator 114_1 may determine whether a value of the first quality information exemplified in the embodiment described with reference to FIG. 7 satisfies the quality criteria predetermined in the quality criteria list 117.

Accordingly, the quality evaluator 114_1 may evaluate the training data candidate based on absolute quality of the training data candidate.

In certain embodiments, the quality comparator 114_2 may compute a first comparison result obtained by comparing the first biometric information of the training data candidate with the second biometric information of the second data. Alternatively, the quality comparator 114_2 may calculate a second comparison result obtained by comparing the first quality information of the training data candidate with the second quality information of the second data. For example, the quality comparator 114_2 may compare the training data candidate and the second data for at least one identical quality feature. The first comparison result and the second comparison result may be proportional results. For example, the first comparison result may be a ratio of a value of the first biometric information to a value of the second biometric information for a specific quality feature. For example, the first comparison result may be a ratio of the number of ending points extracted from the training data candidate to the number of ending points extracted from the second data.

The biometric information extractor 112 of FIG. 6 and the quality information extractor 113 of FIG. 7 may extract the second biometric information and the second quality information from the second data Ic of FIG. 2, respectively. The biometric information extractor 112 and the quality information extractor 113 may extract the second biometric information and the second quality information from the second data Ic in the same manner as the first biometric information and the first quality information, respectively.

The quality comparator 114_2 may evaluate the first biometric information and the first quality information based on at least one of the first comparison result and the second comparison result. For example, the quality comparator 114_2 may determine whether at least one of the first comparison result and the second comparison result meets or exceeds a predetermined reference ratio. Alternatively, the quality comparator 114_2 may compute the first comparison result and the second comparison result for all quality features and determine the number of quality features, among the comparison results for all quality features that meet or exceed the predetermined reference ratio.

Accordingly, the training data candidate evaluator 114 may evaluate the training data candidate based on the relative quality of the training data candidate for the second data Ic including real biometric information.

The training data candidate evaluator 114 may determine whether the training data candidate is appropriate to training data, based on at least a portion of the evaluation results of the quality evaluator 114_1 and the quality comparator 114_2. The training data candidate evaluator 114 may provide training data candidates determined to be appropriate to the training data labeler 115 of FIG. 3. Alternatively, the training data candidate evaluator 114 may provide the evaluation results of the training data candidate to the training data labeler 115 of FIG. 3.

In certain embodiments, the training data candidate evaluator 114 may output first feedback FB1 based on at least a portion of the evaluation results of the quality evaluator 114_1 and the quality comparator 114_2. The first feedback FB1 may be transmitted to the training data candidate generator 111 of FIG. 3.

In certain embodiments, the first feedback FB1 may include information on quality features with low quality evaluation results.

For example, when the biometric information or quality information of the training data candidate does not satisfy the quality criteria predetermined in the quality criteria list 117, a list of the unsatisfied quality features may be output as the first feedback FB1.

For example, when the biometric information or quality information of the training data candidate is relatively low compared to the second data, a list of the low-quality features may be output as the first feedback FB1.

As described in the embodiment with reference to FIG. 4, the parameter adjusting module 111_3 of FIG. 4 may check the quality features in the first feedback FB1 and confirm information of parameters corresponding to the quality features in the parameter mapping list 116_1 of FIG. 5. The parameter adjusting module 111_3 may adjust values of the parameters corresponding to the quality features.

Accordingly, the training device 100 may improve the quality of the training data candidate based on the first feedback FB1. The training device 100 may enhance the performance of the training data candidate generator 111 based on the quality of the training data candidate. As a result, the training device 100 may improve the quality of the training data.

FIG. 9 is a diagram illustrating an operation in which the training data labeler 115 labels generated training data candidates and constructing training data, according to one or more embodiments. The training data labeler 115 of FIG. 9 may correspond to the training data labeler 115 of FIG. 3.

The training data labeler 115 may label training data candidates satisfying a criteria of a predetermined quality evaluation, among the training data candidates, based on the evaluation results of the training data candidate evaluator 114 of FIG. 8 and include the labeled training data candidate in the training data.

The training data labeler 115 may set a training data candidate as training data TD1 labeled as forged biometric information when the training data candidate is generated from first data Is1 including forged biometric information and second data Ic1 including real biometric information.

The training data labeler 115 may set a training data candidate as training data TD2 labeled as real biometric information when the training data candidate is generated from first data Is2 including real biometric information and second data Ic2 including real biometric information. In some embodiments, the training data labeler may identify a type of biometric information of each of the first data and the second data before setting a training data candidate label.

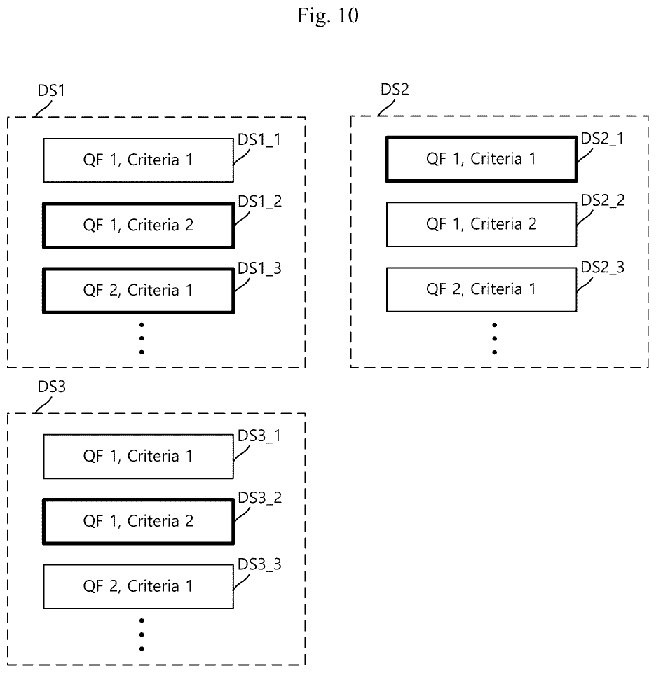

FIG. 10 is a diagram illustrating an operation in which the training device 100 of FIG. 1 generates a plurality of candidate training data sets, according to one or more embodiments.

In certain embodiments, the training device 100 may generate a plurality of training data candidate sets.

For example, FIG. 10 illustrates that the training device 100 generates three training data candidate sets DS1, DS2, and DS3. However, the training device 100 may generate a number of training data candidate sets fewer or greater than three.

In certain embodiments, the training device 100 may generate the plurality of training data candidate sets based on the type of first data including forged biometric information. For example, the first data may be obtained through a sensor from fingerprints transferred to various materials such as liquid latex body paint, clay, glue, gelatin, fingerprints printed on transparent materials, fingerprints two-dimensionally printed on paper, or silicone. The first data may include data obtained from fingerprints transferred to materials other than fingerprints directly obtained from a human finger.

The training device 100 may generate different training data candidate sets depending on the type of material to which the fingerprint is transferred. For example, the first training data candidate set DS1 may include training data candidates generated using first data obtained from a clay-like material to which a fingerprint is transferred and second data including real fingerprint information. The second training data candidate set DS2 and the third training data candidate set DS3 may each include training data candidates generated using first data obtained from different types of materials and second data including real fingerprint information.

In certain embodiments, the training device 100 may generate different sub-training data candidate sets based on quality criteria. For example, the training device 100 may generate different sub-training data candidate sets based on different quality criteria for quality features.

For example, referring to FIG. 10, the training device 100 may divide the first training data candidate set DS1 into a first sub-training data candidate set DS1_1 satisfying a first quality criterion for a first quality feature, a second sub-training data candidate set DS1_2 satisfying a second quality criterion for the first quality feature, a third sub-training data candidate set DS1_3 satisfying a first quality criterion for a second quality feature, or the like. Similarly, the training device 100 may divide the second training data candidate set DS2 and the third training data candidate set DS3 into different sub-training data candidate sets DS2_1, DS2_2, DS2_3, DS3_1, DS3_2, DS3_3, . . . based on different quality criteria for quality features.

The biometric information forgery detection model trainer 120 may train or fine-tune the biometric information forgery detection model using each sub-training data candidate set and verify the detection performance of the trained or fine-tuned forgery detection model.

The training device 100 may include sub-training data candidate sets exhibiting detection performance above a predetermined threshold in the training data based on the detection performance of each sub-training data candidate set.

For example, referring to FIG. 10, the training device 100 may include second sub-training data candidate set DS1_2 and third sub-training data candidate set DS1_3 from the first training data candidate set DS1 in the training data. Similarly, the training device 100 may include first sub-training data candidate set DS2_1 from the second training data candidate set DS2 in the training data. The training device 100 may include second sub-training data candidate set DS3_2 from the third training data candidate set DS3 in the training data.

FIG. 11 is a diagram illustrating the second feedback FB2 of the biometric information forgery detection model trainer 120 of FIG. 3.

The biometric information forgery detection model trainer 120 may train a biometric information forgery detection model to detect forged biometric information using training data.

In certain embodiments, the training device 100 may classify different sub-training data sets depending on quality criteria based on the detection performance thereof.

In certain embodiments, the biometric information forgery detection model trainer 120 may output second feedback FB2 based on the detection performance of the plurality of sub-training data sets.

For example, as described in the embodiment of FIG. 10, the biometric information forgery detection model may be trained or fine-tuned using each of the sub-training data candidate sets, and detection performance of the trained or fine-tuned forgery detection model may be checked. The biometric information forgery detection model trainer 120 may classify the sub-training data candidate sets based on detection performance into sub-training data candidate sets DS_a, DS_b, and DS_c exhibiting detection performance PF_High above a predetermined reference and sub-training data candidate sets DS_d, DS_e, and DS_f exhibiting detection performance PF_Low below the predetermined reference.

In certain embodiments, the biometric information forgery detection model trainer 120 may output second feedback FB2 using information from the sub-training data candidate sets classified based on the detection performance.

In certain embodiments, the biometric information forgery detection model trainer 120 may output a quality feature, common to at least some of the sub-training data candidate sets DS_a, DS_b, and DS_c exhibiting high detection performance PF_High, as second feedback FB2. For example, referring to FIG. 10, the biometric information forgery detection model trainer 120 may output a first quality feature QF1, common to two sub-training data candidate sets DS_a and DS_b exhibiting high detection performance PF_High, as second feedback FB2.

In certain embodiments, the biometric information forgery detection model trainer 120 may output a quality feature, common to at least some of the sub-training data candidate sets DS_d, DS_e, and DS_f exhibiting low detection performance PF_Low, as second feedback FB2. For example, referring to FIG. 10, the biometric information forgery detection model trainer 120 may output a third quality feature QF3, common to two sub-training data candidate sets DS_d, DS_e exhibiting low detection performance PF_Low, as second feedback FB2.

In certain embodiments, the biometric information forgery detection model trainer 120 may output the quality criteria of a sub-training data candidate set DS_f, exhibiting both high detection performance PF_High and low detection performance PF_Low, as second feedback FB2. For example, referring to FIG. 10, the biometric information forgery detection model trainer 120 may output the quality criteria QF2, Criteria 1, and Criteria 2 of the sub-training data candidate set DS_f, exhibiting both high detection performance PF_High and low detection performance PF_Low, as second feedback FB2.

In certain embodiments, the training data generator 110 of FIG. 3 may change the parameter values of the non-biometric information transfer model 111_2 of FIG. 4 based on the second feedback FB2.

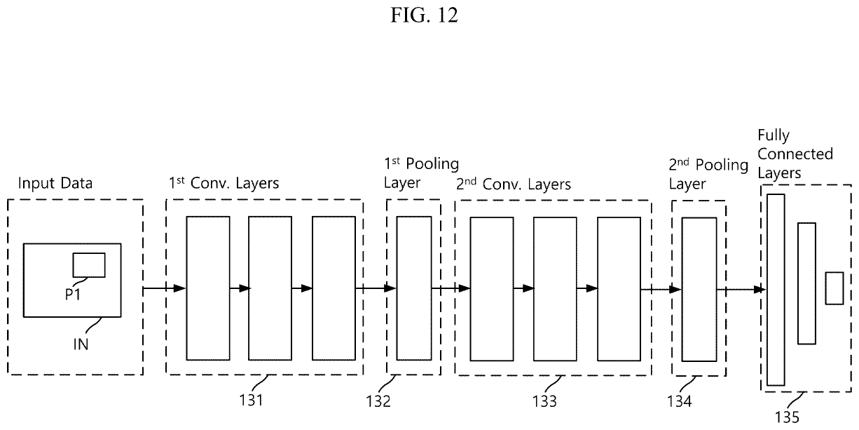

FIG. 12 is a diagram illustrating an example of the configuration of a biometric information forgery detection model.

The biometric information forgery detection model of FIG. 12 may be trained in the training device 100 of FIG. 1 and used for biometric information forgery detection performed by a biometric information forgery detector 220 of a biometric information authentication device 200.

In FIG. 12, an example is provided in which the biometric information forgery detection model includes first convolution layers 131, a first pooling layer 132, second convolution layers 133, a second pooling layer 134, and fully connected layers 135.

FIG. 12 illustrates an example in which the first convolution layers 131 and the second convolution layers 133 each include three convolution layers, but the biometric information forgery detection model according to one or more embodiments is not limited thereto. For example, one or more embodiments are not limited to the biometric information forgery detection model structure of FIG. 12, and various structures of detection models may be used.

In certain embodiments, the biometric information forgery detection model may receive an input image IN obtained from a sensor. Alternatively, the biometric information forgery detection model may receive a patch image P1 of the input image IN.

For example, when the biometric information forgery detection model is used in a lightweight biometric information authentication device 200 such as a smart card, the biometric information forgery detection model may receive the patch image P1 of the input image IN.

In certain embodiments, the biometric information forgery detection model may receive patch images extracted from the plurality of portions of the input image IN. The biometric information forgery detection model may compute a forgery probability for each patch image and determine whether the input image IN is forged, based on the forgery probability of each patch image.

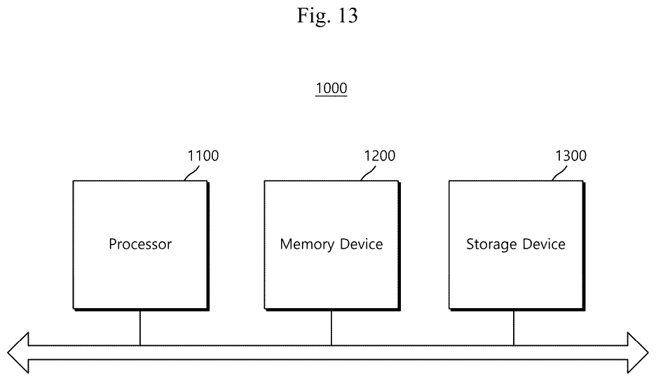

FIG. 13 is a diagram illustrating an example of the configuration of a training device 1000 (hereinafter referred to as a “training device”) of a biometric information forgery detection model.

Referring to FIG. 13, the training device 1000 may include a processor 1100, a memory device 1200, and a storage device 1300.

In certain embodiments, the processor 1100 may perform operations corresponding to respective operations of the training method of FIG. 2 based on instructions stored in the memory device 1200.

The processor 1100 may execute instructions and control the training device 1000. The instructions executed by the processor 810 may be stored in the memory device 1200.

The memory device 1200 may store data supporting functionality of the training device 1000.

The memory device 1200 may store a plurality of pieces of data for the operation of the processor 1100 (for example, at least one algorithm information for training). The memory device 1200 may store a learning model. The stored learning model may be a fully trained learning model or a learning model that has not yet been fully trained.

The learning model may be implemented in hardware, software, or a combination thereof. When a portion or all of the learning model is implemented in software, one or more instructions constituting the learning model may be stored in the memory device 1200.

The storage device 1300 may store data. For example, the storage device 1300 may store the first data and second data described with reference to FIGS. 1 to 12. The storage device 1300 may be a non-volatile storage device.

The present disclosure may be implemented as computer-readable codes on a program-recorded medium. The computer-readable recording medium may be any recording medium that stores data which can be thereafter read by a computer system. Examples of the computer-readable medium may include hard disk drive (HDD), solid state disk (SSD), silicon disk drive (SDD), read-only memory (ROM), random-access memory (RAM), CD-ROM, a magnetic tape, a floppy disk, and an optical data storage device. In addition, the computer can include a processor of a terminal

As set forth above, according to one or more embodiments, training method and device may provide enabling cost-effective training method and device of a biometric information forgery detection model while maintaining or enhancing the detection performance thereof.

While various embodiments have been shown and described above, it will be apparent to those skilled in the art that modifications and variations could be made without departing from the scope of the present inventive concept as defined by the appended claims.

What is claimed is:

1. A training method of a biometric information forgery detection model, the training method comprising:
selecting first data and second data;
extracting non-biometric information of the first data and biometric information of the second data based on a deep learning-based generative model;
generating training data candidates by transferring the non-biometric information of the first data to the biometric information of the second data based on the deep learning-based generative model;
extracting first biometric information and first quality information of the training data candidates;
evaluating the first biometric information and the first quality information of the training data candidate based on predetermined quality criteria; and
selecting a training data satisfying the predetermined quality criteria from the training data candidates.

2. The training method of claim 1, further comprising:
identifying a type of biometric information of each of the first data and the second data;
setting the training data candidates as training data labeled as forged biometric information in response to the training data candidates are generated from the first data comprising forged biometric information and the second data comprising first real biometric information; and
setting the training data candidates as training data labeled as real biometric information in response to the training data candidates are generated from the first data comprising second real biometric information and the second data comprising third real biometric information.

3. The training method of claim 1, further comprising:
training the biometric information forgery detection model to detect forged biometric information based on the training data; and
adjusting parameters of the deep learning-based generative model based on detection performance of the biometric information forgery detection model.

4. The training method of claim 3, further comprising:
generating a plurality of training data candidate sets based on at least one of a type of the forged biometric information and the predetermined quality criteria;
checking the detection performance of the biometric information forgery detection model trained based on each of the plurality of training data candidate sets; and
adjusting the parameters of the deep learning-based generative model based on the detection performance.

5. The training method of claim 4, further comprising:
determining at least one of the first biometric information and the first quality information;
checking a pre-mapped parameter pre-mapped to the first biometric information and the first quality information; and
changing a value of the pre-mapped parameter.

6. The training method of claim 1, further comprising:
generating a plurality of training data candidate sets based on a type of forged biometric information and the predetermined quality criteria;
checking detection performance of the biometric information forgery detection model trained based on each of the plurality of training data candidate sets; and
determining training data based on the detection performance.

7. The training method of claim 1, wherein:
the evaluating the first biometric information and the first quality information of the training data candidate based on the preset quality criteria comprises:
checking whether at least one of the first biometric information and the first quality information satisfies the predetermined quality criteria.

8. The training method of claim 7, further comprising:
adjusting parameters of the deep learning-based generative model based on whether at least one of the first biometric information and the first quality information satisfies the predetermined quality criteria.

9. The training method of claim 8, further comprising:
checking a pre-mapped parameter pre-mapped to the first biometric information and the first quality information, among the parameters of the deep learning-based generative model, in response to at least one of the first biometric information and the first quality information does not satisfy the predetermined quality criteria; and
changing a value of the pre-mapped parameter.

10. The training method of claim 1, further comprising:
extracting second biometric information and second quality information of the second data;
computing a first comparison result obtained by comparing the first biometric information with the second biometric information or computing a second comparison result obtained by comparing the first quality information with the second quality information; and
evaluating the first biometric information and the first quality information based on at least one of the first comparison result and the second comparison result.

11. The training method of claim 10, further comprising:
adjusting parameters of the deep learning-based generative model based on at least one of the first comparison result and the second comparison result.

12. The training method of claim 11, further comprising:
checking a parameter pre-mapped to the first biometric information and the first quality information, among the parameters of the deep learning-based generative model, when at least one of the first comparison result and the second comparison result does not satisfy predetermined criteria; and
changing a value of the pre-mapped parameter.

13. A training device of a biometric information forgery detection model, the training device comprising:
a processor; and
a memory electrically connected to the processor and configured to store at least one instruction executed by the processor,
wherein the at least one instruction controls the processor to:
select first data and second data;
extract non-biometric information of the first data based on a deep learning-based generative model;
generate training data candidates by transferring the non-biometric information of the first data to biometric information of the second data using the deep learning-based generative model;
calculate first biometric information and first quality information of the training data candidates;
evaluate the first biometric information and the first quality information of the training data candidates based on predetermined quality criteria; and
select a selected training data candidate from the training data candidates, satisfying the quality criteria, to generate training data.

14. The training device of claim 13, wherein the at least one instruction controls the processor further to:
train the biometric information forgery detection model to detect forged biometric information based on the training data; and
adjust parameters of the deep learning-based generative model based on detection performance of the biometric information forgery detection model.

15. The training device of claim 14, wherein the at least one instruction controls the processor further to:
generate a plurality of training data candidate sets based on at least one of a type of the forged biometric information and the predetermined quality criteria;
check the detection performance of the biometric information forgery detection model trained based on each of the plurality of training data candidate sets; and
adjust the parameters of the deep learning-based generative model based on the detection performance.

16. The training device of claim 13, wherein the at least one instruction controls the processor further to:
generate a plurality of training data candidate sets based on a type of forged biometric information and the predetermined quality criteria;
check detection performance of the biometric information forgery detection model trained based on each of the plurality of training data candidate sets; and
determine the training data based on the detection performance.

17. The training device of claim 13, wherein the at least one instruction controls the processor further to:
check whether at least one of the first biometric information and the first quality information satisfies the predetermined quality criteria.

18. The training device of claim 17, wherein the at least one instruction controls the processor further to:
adjust parameters of the deep learning-based generative model based on whether at least one of the first biometric information and the first quality information satisfies the predetermined quality criteria.

19. The training device of claim 18, wherein the at least one instruction controls the processor further to:
check a pre-mapped parameter pre-mapped to the first biometric information and the first quality information, among the parameters of the deep learning-based generative model, in response to at least one of the first biometric information and the first quality information does not satisfy the predetermined quality criteria; and
change a value of the pre-mapped parameter.

20. A training method of a biometric information forgery detection model, the training method comprising:
selecting first data and second data;
extracting non-biometric information of the first data using a deep learning-based generative model;
generating training data candidates by transferring the non-biometric information of the first data to biometric information of the second data using the deep learning-based generative model;
evaluating a quality of the training data candidates based on predetermined quality criteria;
and setting a selected training data candidate of the training data candidates, satisfying the quality criteria, as training data.
